(19) United States
(12) Patent Application Publication
(10) Pub. No.: US 2007/0295127 A1
(43) Pub. Date: Dec. 27, 2007

(54) Mechanical method and assembly for actuator travel limit

(75) Inventor: Yueh Han Li, Taichung (TW)

Correspondence Address: CHARLES E. BAXLEY, ESQ., 90 JOHN STREET, THIRD FLOOR, NEW YORK, NY, 10038, US

(73) Assignee: Hiwin Mikrosystem Corp.

(21) Appl. No.: 11/444,195

(22) Filed: May 31, 2006

(51) Int. Cl. F16H 29/02; F16H 27/02

(52) U.S. Cl. 74/89.37

(57) ABSTRACT

A mechanical method and assembly for actuator travel limit substantially comprises at least one limit switch placed in a travel of a linear machine, a starting device associated to said linear machine for activating the limit switch, and a linker for connecting said linear machine and starting device. When the linear machine arrives at the limit position and a jog occurs, said linker eliminates the displacement of the starting device caused by the jog and retains the starting device connecting with the limit switch.

### BACKGROUND OF THE INVENTION

1. Field of the Invention

The present invention relates to actuator travel limit apparatus and, more particularly, the subject matter disclosed hereafter is accommodative to any cases where limit switches are implemented to control a mechanical travel.

2. Description of Related Art

Limit switches are typically utilized in mechanical travel limit systems. When a mechanism travels to a preset limit position, a limit switch is activated and sends a particular instruction to a central control system to conduct a predetermined motion such as shutting off the machine, starting a protection mechanism or alert mechanism.

However, jogs may often arise by reasons of external force, machine loading or other factors, and may render the machine departing from and returning back to the limit position fleetingly. This incurs a transient restart of the limit switch and accordingly makes the limit switch deliver continuous and improper messages to said central control system. In consequence, such a jog would be a detrimental to the machine for probably raising the failure rate in a significant way.

### SUMMARY OF THE INVENTION

The objectives of this invention are to create a mechanism, which eliminates an interference with a limit switch from a jog while a mechanism arrives at its preset limit position.

Some certain pre-processes prior to the disclosed subject matter are including:

programming a linear travel of a machine;

setting limit positions of said linear travel;

placing limit switches at said limit positions;

providing a starting device for actuating the limit switches while the machine arrives at said limit positions; and

estimating the jog distance of the linear machine.

Foresaid pre-processes provide useful information to the inventor for achieving a technical solution of coupling the starting device and the machine to eliminate an interference with the starting device from a jog and to remain the starting device at the reached limit position where it contacts the reached limit switch.

The disclosed technical measure is including, but not limited to, a movable connection between a linker and the starting device. The movable connection permits the linker drawing the starting device to move simultaneously throughout foresaid mechanical travel and in case a jog occurs when the machine arrives at the limit position; the movable connection counteracts the displacement brought by the jog and enables the starting device to remain at the reached limit position.

### BRIEF DESCRIPTION OF THE DRAWINGS

The invention as well as a preferred mode of use, further objectives and advantages thereof, will best be understood by reference to the following detailed description of an illustrative embodiment when read in conjunction with the accompanying drawings, wherein:

FIG. 1 is a schematic drawing showing a typical linear machine according to the present invention.

FIG. 2 is a schematic drawing showing a move of the linear machine according to FIG. 1.

FIG. 3 is a schematic drawing showing a further move of the linear machine according to FIG. 2.

FIG. 4 is a schematic drawing showing the displacement brought by a jog being counteracted by the measures according to the present invention.

FIG. 5 is an exploded view of an embodiment of the starting device according to the present invention.

FIG. 6 is a perspective view of an embodiment of the starting device according to the present invention.

FIG. 7 is a schematic view showing the starting device according to the present invention applied on a typical linear machine.

FIG. 8 is a sectional view taken along Line 8-8 of FIG. 7.

### DETAILED DESCRIPTION OF THE PREFERRED EMBODIMENT

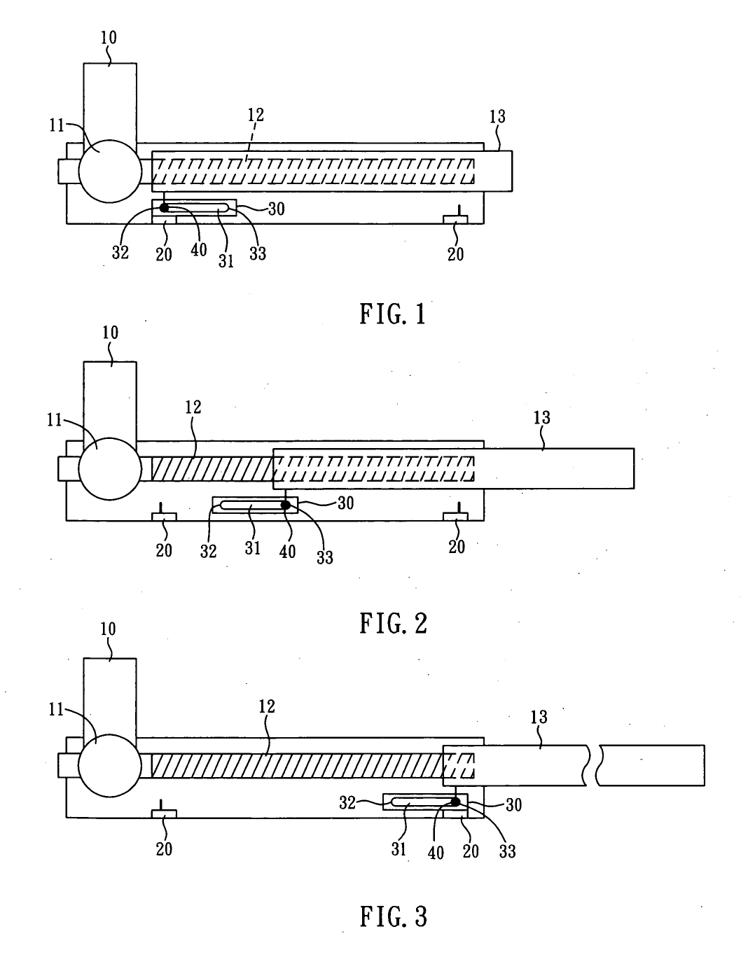

FIGS. 1, 2 and 3 are summarily illustrating a linear machine where a motor 10 drives a transmission 11, the transmission 11 in turn drives a screw shaft 12, and as the screw shaft 12 rotating clockwise or anti-clockwise, a linear mechanism 13 engaged thereon moves back and forth linearly. The travel of the linear mechanism 13 is limited by two limit switches 20 which are to be activated by a starting device 30 of the linear mechanism 13. Wherein, the linear mechanism 13 and the starting device 30 are coupled together by means of a linker 40 which is movably combined with the starting device 30.

The means for combining the linker 40 with the starting device 30 movably is including, but not limited to, equipping the starting device 30 with a track 31 which engages one end of the linker 40 and allows the linker 40 moving along through the track 31 freely. Therefore, when the linker 40 arrives at one of the ends 32, 33 of the track 31, the starting device 30 would be drawn by the linear mechanism 13 and move accordingly, and as the linear mechanism 13 arriving the limit positions, the starting device 30 activates the relative limit switches 20.

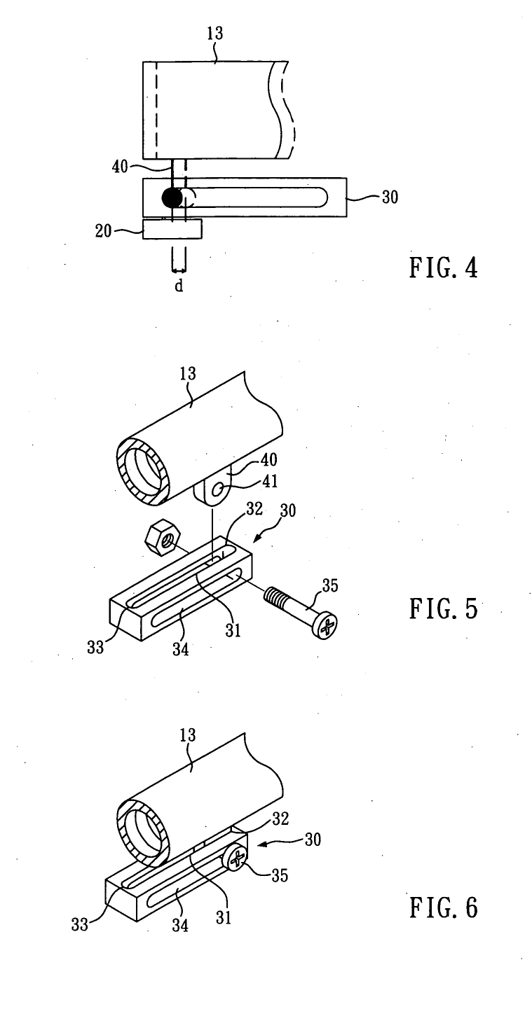

Referring to FIG. 4, once a jog effects upon the linear mechanism 13 (as shown in FIG. 4 by dotted lines) at the moment when the starting device 30 activates the limit switch 20, a jog distance (d) therefore exists and the jog acting on the linker 40 is immediately cushioned and counteracted by the length of the track 31. Thereby, the starting device 30 can be free from the interference from the jog and remains at the limit position where it touches the limit switch 20.

One embodiment of the movable connection between the starting device 30 and linker 40 according to the present invention is shown in FIGS. 5 and 6. This embodiment is set to express the enforceability of the disclosed subject matter and is not the only measures to enforce the present invention. Said figures illustrate part of the linear mechanism 13 where a linker 40 associated to. The linker 40 is pivotally combined with the starting device 30 through a track 31 provided therein and thereby the linker 40 is capable of sliding freely along through the track. The starting device 30 further comprises a pair of slots 34 positioned on opposite sides to permit a combining component 35 passing through and further piercing into a hole 41 on the linker 40 for combining the linker 40 with the starting device 30. Note that the combining component 35 should not be pressed on to the starting device 30 otherwise the linker 40 and combining component 35 becomes unmovable to both the track 31 and slots 34. It is preferable that the combining component 35 and starting device 30 are combined with proper transferability.

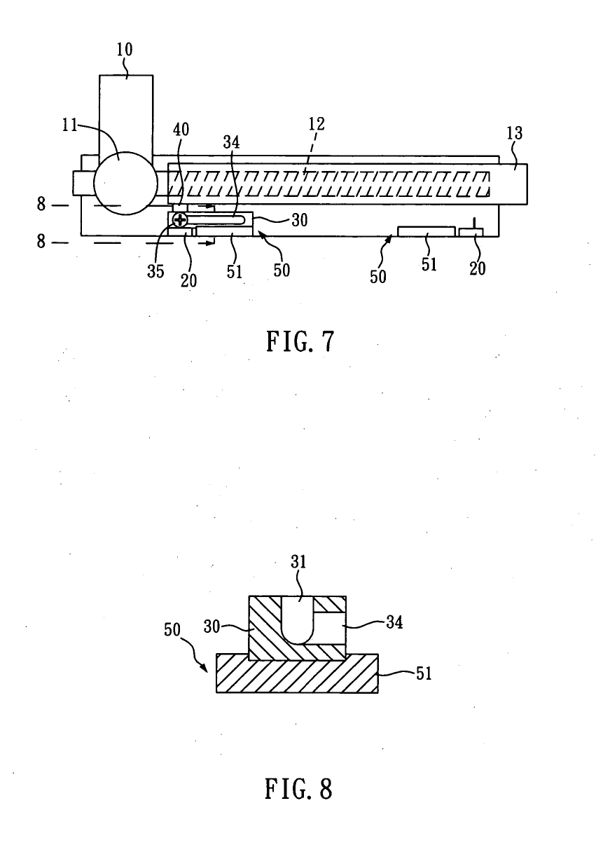

In FIGS. 7 and 8, for further preventing a jog form undesirably displacing the starting device 30, a damper 50 is provided adjacent to each limit switch 20. The damper 50 is including, but not limited to a damping rail 51. Damping force generated from the damping rail 51 helps to retain the starting device 30 with the limit switch 20 by proper resistance and thereby efficiently counteracts the jog acting on the linear mechanism 13 and linker 40.

Although a particular embodiment of the invention has been described in detail for purposes of illustration, various modifications and enhancements may be made without departing from the spirit and scope of the invention. Accordingly, the invention is not to be limited except as by the appended claims.

What the invention claimed is:

1. A mechanical method and assembly for actuator travel limit, comprising:
programming a linear travel of a machine;
setting at least one limit position of said linear travel;
placing at least one limit switch at said at least one limit position;
providing a starting device for actuating the relative limit switch when the machine arrives at the at least one limit position;
estimating the jog distance of said linear machine; and
combining the and starting device with the linear machine by means of a linker;
wherein when the linear mechanism arrives at the limit position and a jog occurs, said linker prevents the displacement of the starting device caused by the jog and retains the starting device connecting with the limit switch.

2. A mechanical method and assembly for actuator travel limit as claimed in claim 1, wherein the linker is movably combined with the starting device.

3. A mechanical method and assembly for actuator travel limit, comprising:
at least one limit switch placed at least one limit position of a travel of a linear mechanism;
a starting device associated to said linear mechanism for activating the limit switches; and
a linker for combining said linear machine with said starting device;
wherein when the linear mechanism arrives at the limit position and a jog occurs, said linker eliminates the displacement of the starting device caused by the jog and retains the starting device connecting with the limit switch.

4. A mechanical method and assembly for actuator travel limit as claimed in claim 3, wherein the linker is movably combined with the starting device.

5. A mechanical method and assembly for actuator travel limit as claimed in claim 4, wherein the starting device further comprises an end-sealed track to receive with one end of the linker and permit the linker to move along through the track.

6. A mechanical method and assembly for actuator travel limit as claimed in claim 5, wherein the other end of the linker is fixedly fastened on the linear mechanism.

7. A mechanical method and assembly for actuator travel limit as claimed in claim 3, further comprises a damper disposed adjacent to the limit switch to provide damping force to the starting device.
